(19) United States
(12) Patent Application Publication
(10) Pub. No.: US 2009/0298575 A1
(43) Pub. Date: Dec. 3, 2009

(54) Monitoring Networked Entertainment Devices

(76) Inventors: Alistair Hopkins, Gwynedd (GB); Andrew Guy Olliver, East Sussex (GB)

Correspondence Address: William J. McNichol, Jr.;Reed Smith, 2500 One LIberty Place, 1650 Market Street, Philadelphia, PA, 19103, US

(21) Appl. No.: 12/087,233

(22) PCT Filed: Mar. 31, 2006
(86) PCT No.: PCT/GB2006/001160

§ 371 Date: May 7, 2009

(30) Foreign Application Priority Data
Dec. 29, 2005 (GB) 0526553.3

(51) Int. Cl. G06F 17/00

(52) U.S. Cl. 463/25; 463/42; 463/43

(57) ABSTRACT

Pay to play entertainment machines or devices for gaming, gambling and other entertainment functions used in public spaces such as bars, clubs etc are networked and centrally controlled. A set of schedules is established, each schedule defining a set of attributes for operation of an entertainment device and stored in a database. Each entertainment device in the network is associated with one or more groups of devices, each group having a specified one of said schedules. For each entertainment device in the network, all the schedules that apply to that device are used to determine a subset of attributes that shall prevail in that device and the device is then automatically configured to have that subset of attributes. Event messages generated in each entertainment device are transmitted to a central messaging server on a real-time or batch process basis according to a priority level. A priority is set to the different event messages maintained in the queue.

The present invention relates to networked entertainment devices and in particular to entertainment machines or devices incorporating some form of payment mechanism for use in public spaces such as bars, clubs, pubs, arcades and the like. Examples of such networked entertainment devices include video and/or audio jukeboxes, gambling machines such as slot machines including so-called ‘one-armed bandits’ and playing card game based systems, automated betting systems for both real and virtual events, video gaming machines and general arcade games.

There are a large number of different types of coin, token and card operated entertainment devices in the public space. Each type of device can have significantly different properties, in terms of the entertainment functions provided, the entertainment content available for display and use, and the permissible rules of operation of the machine. There has recently been a trend towards providing multi-function machines in which software and firmware can be configured on generic processor-based machines in order to provide a range of different possibilities for the type of entertainment content being offered. This enables common hardware to be used in many different environments, configured to provide entertainment content according to local requirements, legislation etc. This also enables entertainment content to be updated more readily as business requirements and popularity of entertainment content change.

For example, in a common application, a slot machine may provide an assortment of arcade games, quiz games and gambling games. Some of the entertainment content may be universal, i.e. provided on all machines of that type, while some may be selected by the manager of the premises in which the machine is operated. Some of the entertainment content may be admissible only during certain hours of the day, e.g. in the case of family pubs. The slot machine may be configured to display advertising material while in a standby mode of operation or during game play. The slot machine may be configured to display information related to local activities or events such as a happy hour drink offer or pub quiz. The local environment in which a machine operates, both real (e.g. physical and geographical location) and virtual (e.g. legislative and business environment) will collectively be referred to in this specification as the domain of operation.

There has also recently been a trend towards networking entertainment devices so that they can, to some extent, be controlled, configured and/or monitored remotely over the public telecommunications network. For example, it is now well-known for jukebox systems to routinely download new audio and video content from a central server as newer content is released and becomes popular.

A problem with configuration of generic entertainment devices is the complexity of the task of ensuring that each device controlled within a large network is configured, maintained and operated in an appropriate manner for its current domain of operation. As suggested above, there are often a very large number of competing requirements that must be taken into account.

For example, the owner or operator of such entertainment devices may require specific controls in respect of entertainment content, pricing, advertising content etc. while allowing the local business (e.g. pub) in whose premises the device resides some flexibility in determining content which is locally popular, relevant to local trade, or useful in specific promotions. Furthermore, third parties such as licensees, sponsors, etc may have an interest in ensuring that advertising content appears in association with relevant entertainment content and possibly also at specific times and in specific formats. Furthermore, strict legislation controlling the use of entertainment devices is often determined on both a national and a regional level, as well as being specific to the type of premises in which the device is being operated and the type of entertainment content being offered. For example, legislation may govern both the type of entertainment content (e.g. gambling or game play) as well as the functionality (amount of payout or form of payout). Thus, ensuring that each entertainment machine in a large distributed network of machines is configured to operate correctly is a difficult task usually requiring complex preparation prior to installation and on-site service visits to configure and reconfigure machines.

Another problem in maintaining a large network of entertainment devices offering different entertainment content in different domains of operation is that of collecting activity data. Different devices will have different configurations giving rise to manly different types of event messages, such as times and amounts of payments-in and payments-out, self-generated error messages and calls for maintenance and tamper alarms. Some event messages may be time critical, requiring immediate or urgent delivery while some may be relatively time insensitive. For a large number of machines in a widespread network, it is a very difficult task to ensure that event messages are passed to the appropriate organisation within an appropriate time period, without consuming large amounts of communication channel bandwidth.

It would be highly desirable for entertainment devices to be managed centrally from a central or distributed control server in a manner that ensures that all machines in the network are configured correctly for their domain of operation. It would also be highly desirable for each networked entertainment device to be remotely monitorable to verify its present configuration. It would also be highly desirable to be able to remotely control the configuration of each machine. It would also be highly desirable to provide for expedient delivery of event messages generated by different entertainment devices to appropriate entities according to the type of event message.

It is an object of the present invention to provide an improved networkable entertainment device which overcomes some or all of the problems associated with prior art devices.

According to another aspect, the present invention provides a method for operating a network of entertainment devices each having an attached payment mechanism, comprising the steps of:

(i) in each entertainment device, generating a plurality of event messages of different types based on physical and/or virtual events occurring in the entertainment device;
(ii) sending each event message, over the network to a message server;
(iii) forwarding, by the message server, to a plurality of subscriber entities, respective subsets of the event messages received by the message serves according to a classification and/or attribute of the messages and according to a subscription basis of the respective subscriber entities.

According to another aspect, the present invention provides an entertainment device comprising:
a payment mechanism;
a processor module for executing entertainment content;
a plurality of modules each adapted to initiate event messages corresponding to virtual or physical changes in the condition of the entertainment device; and
a messaging module for sending said event messages to a remotely located message server for onward distribution to subscriber entities based on a classification or attribute of the message.

According to another aspect, the present invention provides an entertainment system comprising:
a plurality of entertainment devices each having an attached payment mechanism;
a message server connected to the plurality of entertainment devices over a network;
each entertainment device including a plurality of modules adapted to initiate a plurality of event messages of different types based on physical and/or virtual events occurring in the entertainment device, and a messaging module adapted to send each event message, over the network to the message server;
the message server adapted to forward subsets of the event messages received by the message server, to respective pluralities of subscriber entities, according to a classification and/or attribute of the messages and according to a subscription basis of each of the subscriber entities.

Embodiments of the present invention will now be described by way of example and with reference to the accompanying drawings in which:

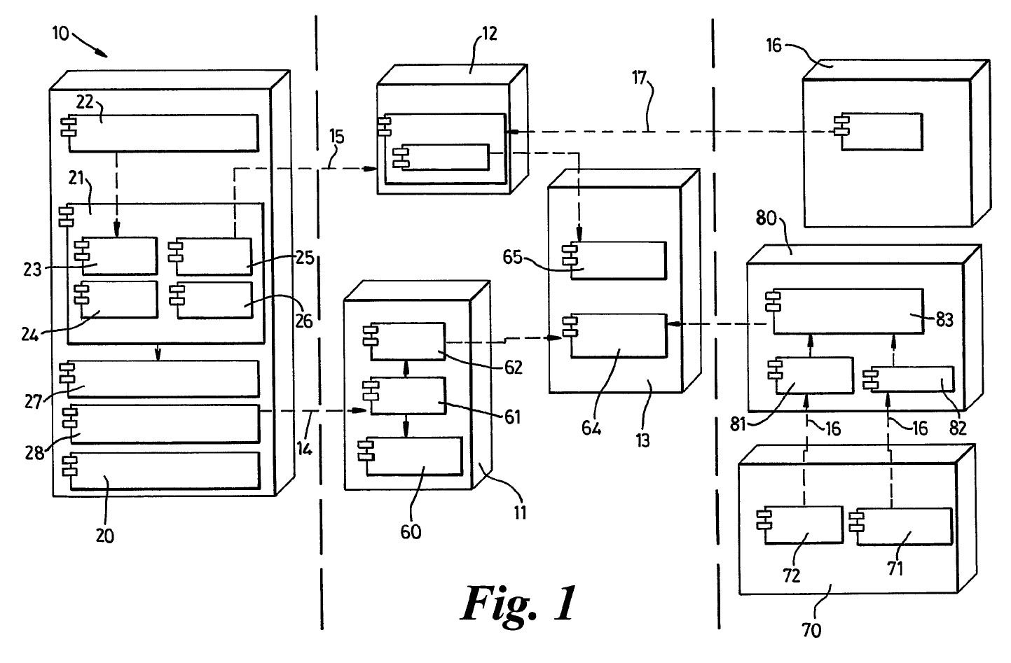

FIG. 1 is a schematic overview of a networked entertainment device and control system; and

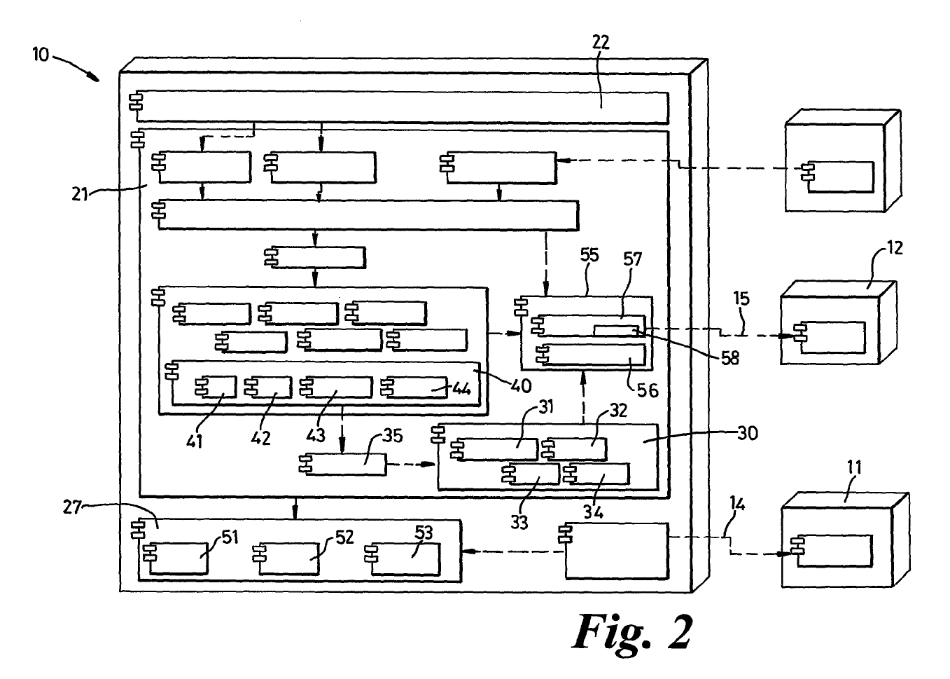

FIG. 2 is a detailed schematic diagram of the entertainment device and server of FIG. 1.

Throughout the present specification, the expression ‘entertainment device’ is used to encompass all forms of ‘pay-to-play’ type machines including gaming machines, gambling machines, audio and video jukeboxes and any other machine adapted to provide digital data content to a user in return for payment via a payment mechanism. Thus, the expression ‘entertainment device’ may also encompass a machine adapted to deliver digital entertainment content (such as audio or video data) directly to a user device, such as an MP3 player.

The digital content delivered to the user may be of the form of an interactive program requiring continuous or periodic input from the user (e.g. a game or a quiz) via a user interface (e.g. keyboard, button set, touch screen, control console etc) or may be a non-interactive program requiring no input from the user once the program is initiated (e.g. the playing of music, a movie clip, advertising or other display content). More generally, the program which runs on the entertainment device to deliver digital content may be referred to herein as ‘payload’.

The expression ‘payment mechanism’ is intended to encompass any form of physical and/or electronic payment mechanism receiving from the user a form of payment token including any one or more of a coin acceptor mechanism, a banknote reader, a credit card reader, a credit token, a proprietary card reader and the like.

FIG. 1 shows an overview of an exemplary networked entertainment device. One entertainment device 10 is shown, connected to a control server 11, a messaging server 12 and a supporting database 13, over network connections 14, 15. It will be understood that many hundreds or thousands of entertainment devices 10 may be connected to the network 14, 15 using any convenient telecommunications network such as the public telephone network, leased private lines or the internet. It will also be understood that the functions of the server 11 and messaging server 12 may be provided by multiple servers. e.g. distributed around a network or provided by a hierarchical network of smaller servers.

Each entertainment device 10 is preferably based on a generic processor running a suitable operating system 20, e.g. Windows XP™ Embedded. Each entertainment device 10 includes a kernel process 21 executable on the operating system for managing content 22, controlling peripherals and communication on the device 10.

The entertainment device 10 includes a plurality of different content executables 22, each relating to a different entertainment content item. A content item may be any item of pay-to-play content, e.g. a game, a quiz, a music player or music track to be played thereon, a video player or video sequence to be played thereon, as well as any advertisement or display sequence to attract attention to the device, a menu for presentation of options to a user, or any executable causing output or transfer of digital content from the entertainment device as a service to the user. As discussed above, the content executables 22 may be referred to as payload.

The kernel process 21 preferably includes a set of components such as: content interfaces 23 which the content executables 22 use to connect to the kernel process 21; service components 24 for providing functions such as paying in, paying out, cash handling and connectivity; a message hub 25 for distributing event messages created within the device 10, e.g. relating to payments in, payment out, play counts, error messages, alarms etc; and other functional components 26 e.g. a credit handler, as will be explained in greater detail later. One content interface 23 may connect to many different content executables 22, and each content interface 23 may support one or more different types of content executable 22.

With reference to FIG. 2, each entertainment device 10 has a plurality of different peripherals 30 specific to its function. These may include, for example, a display output, an audio and/or video output, a user input console, and payment in and payment out mechanisms such as a single coin hopper 31, a banknote reader 32, a coin acceptor 33, and a card reader 34. Other peripherals may be used to model and control more abstract functions, for example connectivity to the network or the current build of the operating system. Each peripheral 30 implements a certain type of functionality or behaviour.

In one aspect, the peripherals 30 comprise all of the non-standard hardware items attached to or integrated into an entertainment device 10. Each peripheral 30 supports a set of functions, e.g. a single coin hopper is a coin hopper which dispenses a single denomination of coin only, and allows for commands like ‘Payout 25 coins’. Services are abstractions of the functions which types of peripherals provide: for example, a coin hopper provides the service ‘Payout’. In different environments, the same peripheral may provide different services. An example of this would be a card reader. In some environments, it may be possible to use an inserted card to take credit and to give credit to the customer—in these environments, the ‘CardReader’ peripheral 34 provides ‘Payin’ and ‘Payout’ services. In other environments, even using exactly the same card, it may only be used for one of those services. The decision as to which peripheral provides which services depends on the wishes of the operator of the entertainment device and may depend on the regulatory environment in which the device is located. The services provided by a peripheral may be entirely controlled through configuration.

As shown in FIG. 2, a peripheral handler 35 controls the set of loaded peripherals and monitors them for health. It will hand peripherals to appropriate services 40, but only as directed by configuration files. Exemplary services include ‘Payin’ service 41, ‘Payout’ service 42, ‘CashHandling’ service 43 and ‘Connectivity’ service 44. If a peripheral 30 becomes unavailable, the peripheral handler 35 will notify all the services which have previously received it. Each service is able to determine whether it is available at any time, given the current state of the entertainment device and the peripherals which are attached and available.

The configuration of the device 10 with respect to the hardware, firmware and software functionality of the device is stored in a configuration database 27 containing a number of configuration files. These may usefully be divided into: core configuration files 51 relating to the configuration of the kernel process and operating system; location-specific configuration files 52 relating to the location and ownership of the entertainment device 10; and content configuration files 53 relating to the configuration of content items 22.

Each content item 22 has a ‘content service type’ which indicates a set of services which must be available on an entertainment device 10 in order for the content item to function properly. It will be evident that a gambling game with cash prizes will need both Payin and Payout services available in order to function. A motor racing game may require specific user console services but will not require Payout services. A video jukebox content item will require specific video and audio output peripherals.

The configuration database 27 is used by the kernel process to establish exactly what services and functionality are available at any given time on the entertainment device 10 and this is used to determine what content is offered to the user. This means that, even if a particular peripheral should fail within the entertainment device, the device is capable of reconfiguring the menu options available to a user to maintain functionality of the device. The menu can simply offer a reduced choice. When the peripheral service becomes available again, then the menu can be modified back to the full range of content again.

Each entertainment device 10 is adapted to operate in a particular domain of operation, which domain defines both physical and virtual environment constraints as defined earlier. For example, the domain of operation may be a public bar which is (i) run bid a local management, (ii) owned by a specific brewery, (iii) in a relationship with certain advertisers, (iv) targeting family clientele during the daytime and adult clientele in the evenings, (v) operating under local authority licensing regulations and (vi) operating under national licensing and gaining laws.

It will be understood that each of these six factors in the domain of operation may influence the way in which the entertainment device is to be operated. Generally speaking, a significant number of such factors determine the allowable or preferred attributes of the entertainment device. The expression ‘attributes’ is intended to encompass the content items or ‘payload’ available on a device, and the mode of operation of those content items. The expression ‘mode of operation’ is intended to encompass rules governing the way in which the content is delivered, restrictions on its input/output parameters and restrictions on the services available to the content.

For example: (i) the pub owner, or brewery may wish to dictate that a certain range of promotional games and offers are available; (ii) the local landlord may recognise that certain games are locally more popular than others and prefer that these are presented with a higher profile; (iii) local management may wish to introduce special offers in conjunction with content delivered by the entertainment device, e.g. an offer to “play game X to win a pint of guest ale”; (iv) a contract between the brewery and another commercial organisation may dictate that predetermined advertising material should appear on the entertainment device display for predetermined periods of time, e.g. when the device is in an idle mode, or even during content item delivery; (v) legislation, regulation or operator preferences may stipulate that certain video or audio jukebox material is not available during the day while families are using the pub; and (vi) gaming laws may dictate certain payout restrictions, possibly at different times of the day.

In prior art systems, it has proved impossible or complex and expensive to configure and reconfigure entertainment devices to meet ever changing requirements for the content offered on the device menu, and the way in which that content executes on the device.

In a preferred embodiment, each entertainment device 10 is assigned to belong to one or more ‘groups’ of such devices 10. Each group has an associated schedule that defines a set of attributes (e.g. content, mode of operation) for all the devices belonging to that group. Those attributes in the schedule may include desired attributes in an order of preference and may include mandatory attributes to comply with regulations.

For example: one schedule may relate to use of an entertainment device in a public bar. Another schedule may relate to use of an entertainment device in a betting shop and another to use in a casino. Each will have different preferences for content items and different regulations as to content items and mode of operation (e.g. payout criteria). Further schedules are then added for specific domains of operation which will influence the attributes of the devices in certain contexts. For example, a device may belong to seven different groups each influencing the desired or mandatory attributes of the device in its domain of operation, consisting of the groups: (i) public bar; (ii) UK gaming legislation; (iii) city centre pub in Coventry; (iv) family access up to 7 pm; no under eighteen access after 7 pm; (v) owned by ‘brewery1’; (vi) run by ‘managementco3’; (vii) advertising agreement with ‘advertiser2’ etc. Each group may have its own schedule defining a set of attributes for operation of an entertainment device. Each attribute listed in the schedule carries an importance weighting, preferably on a numeric scale.

In a simple exemplary arrangement, let us suppose there is a first schedule indicating a menu for a generic pub entertainment device, with importance weighting in brackets:
Entertainment Menu (30)
Game1 (20)
Game2 (40)
Game3 (15)
AdultGame1 (35)
AdultGame2 (10)

Next, suppose there are some special promotional games for ‘Brewery 1’, who own the pub. A customised menu and modified games are required for this brewer. The Brewery1 special schedule looks like:
Brewery1_SpecialMenu (35)
Game3 (15) (mode=Brewery1)
Brewery1_SpecialGame1 (35)

Now, we have a ‘Non-offensive’ schedule. Instead of adding games, this will remove anything that is a bit rude:
AdultGame2 (5) (excluded=true)
AdultGame3 (10) (excluded=true)

In other words, attributes that are determined by a schedule may be ‘negative’ attributes, i.e. the schedule enforces inhibition or removal of some existing functionality.

Lastly, we have signed up with Advertiser1 to do a drink promotion in pubs in the Coventry area and are running an application to manage this:
Advertiser1_payload (50)

Each of these schedules is associated with an appropriate group of machines.

For an entertainment device installed in a family-oriented Brewery1 pub in Coventry, firstly it will launch Brewery1_SpecialMenu (35) since that is the menu with the highest importance weighting. Secondly, that menu will contain, in order, by importance weighting:
Advertiser1_payload (50)
Game2 (40)
Brewery1_SpecialGame1 (35)
AdultGame1 (35)
Game1 (20)
Game3 (15) (mode=Brewery1)

Thus, the combined schedules associated with the particular group membership of the entertainment device have determined both a set of content available to a user of the device, and modes of operation of that device.

It will be understood that mandatory attributes, such as those required in order to comply with legislation, can be given importance weighting values which are not overridable by other elements in schedules. These may be represented by Boolean variables governing the mode of operation of a content item.

Optional schedules may be generated for other users to select from. For example, a pub landlord may be permitted to select from several possible ‘Landlord's Choice’ schedules, which will influence the other schedules according to the choice of additional schedule made by the landlord. Access to modify selected schedules can be restricted according to the privileges granted to each user.

In a further example, schedules may be divided into two types primary schedules and modifying schedules. In the example above, the schedules given are primary schedules. Other persons or organisations involved in operating the entertainment units may be given access rights to introduce modifying schedules.

A modifying schedule is adapted to add or subtract an importance weighting value to or from the importance weighting established by the cumulative primary schedules. So, extending the pub example above, a modifying schedule may assert the following modifying importance weightings:
Advertiser1_SpecialMenu (−5)
Game2 (−5)
Brewery1_SpecialGame1 (+5)
AdultGame1 (−10)
Game1 (+0)
Game3 (+10) (mode=Brewery1)

The final determined attributes for the entertainment device would then be:
Advertiser11 Payload (45)
Brewery1_SpecialGame1 (40)
Game2 (35)
AdultGame1 (25)
Game3 (25) (mode=Brewery)
Game1 (20)

The maximum variance of importance weighting allowed by a modifying schedule may be governed by user access privileges. Modifying schedules may be implemented and adjusted automatically according to a predetermined algorithm driven by input parameters such as number of times the game is played, scores achieved, profit on the content or any other parameter or combination of parameters. Thus, an optimisation engine may be implemented for maximising profit from available content, subject to constraints imposed by primary schedules.

Schedules may be activated only for predetermined periods. Thus, a schedule may be configured to prevail only during certain hours of the day. In a preferred embodiment, each schedule includes a ‘TimePeriod’ field, which may have values indicating that the schedule is active on certain days of the week, certain hours of the day or ‘always’. The activation of the schedule may relate to the schedule as a whole, or to only certain items within the schedule. Thus, in a general sense, the schedules include a time period which indicates the temporal validity or activation of the schedule or of one or more attributes defined in the schedule.

This feature is useful for controlling entertainment content during different hours of the day, but can also be used to vary the price of pay-to-play items throughout the day or week. For example, the content ‘Game2’ could be made more expensive on weekend evenings in all relevant pubs, by adding parameters to the appropriate schedule entry so that the schedule applies 18:00-24:00 Sat Sun, and the entry ‘Game2 (40)’ has a parameter (cost=2.00). Although the importance weighting is unchanged (and therefore the menu order is unchanged), the cost is non-default and the cost parameter in the schedule takes precedence. In another example, certain pubs within a chain could be targeted with selected premium content at certain times of the day.

Schedules may determine other modes of operation for each content item. Generally, these modes could include currency and credit details on the device, language of operation, type of graphics used etc.

The schedules may not only define content items, modes of operation for those content items and menu contents, but also may be used to control layout of content including menus displayed on the entertainment device. Thus, the schedules may determine layout, size and position of control buttons and items on the display. Weighting values may be used to determine which preferred layout will prevail. The layout may determine the number of menu buttons available, the relative sizes of the buttons and their positions on a display independent of the content that will eventually be ascribed to each button, as determined according to all the schedules as discussed above.

The entertainment devices 10 may be configured to use the schedules and weighting values in each relevant schedule in order to ensure that only the top n content items are offered to the user, if it is desired to place strict limits on the total number of items in a menu at any one time. Thus, if the cumulative schedules for a device imply a total of thirty content items, in order of importance, but the device may offer only twenty at any one time, then the device will display only the top twenty according to importance weighting. Should any function of the device become impaired (e.g. loss of a service 40) which would eliminate several content items from availability, other schedule items can be moved up into the available menu. Alternatively, the number of content items offered may be unrestricted according to the total number suggested by the schedules.

Control of the mode of operation of each entertainment device can be implemented entirely remotely by one or more authorised users using appropriate remote interfaces as will now be illustrated (although this does not exclude the possibility also of control at the device itself).

Preferably, the operating system 20 and kernel process 21 are pre-installed in the device 10 and generally remain unchanging, although it will be understood that software upgrades could be delivered over the network 14. Hardware peripherals 30 and associated services 40 are also preferably pre-installed and remain unchanging, although preferably these are modular items that can be swapped by service visits to the device. Different content items 22 and configuration data are delivered to the devices according to the schedules in the following manner.

With further reference to FIG. 1, a content repository 60 is located in server 11 and maintains a structured list of all content items available, including version information if required to ensure that content item compatibility with each entertainment device 10 can be established. The content repository 60 includes content item executables for transfer to entertainment devices 10 or pointers to where to obtain that content elsewhere, if the content items are not already installed on the entertainment devices 10. A data transfer server 61 in server 11 communicates with a corresponding data transfer client 28 in the entertainment device 10 for transfer of content items 22, schedules and configuration files 27. A configuration builder application 62 builds configuration files for transfer to the entertainment devices 10. The configuration data is provided from a suitable configuration database 64 in supporting database server 13. The configuration data in configuration database 64 includes one or more schedules for each group of devices 10 as discussed previously.

One or more management user interfaces or management computers 70 are in communication with a management server 80 over a suitable network connection 16, e.g. the internet. In one embodiment, the management user interface executable 71 resides on the management computer 70 and interacts with the management server 80 via SOAP 82. In another embodiment, access to the management server 80 may be via a web browser 72 installed on the management computer 70 which communicates with a web application 81 to manipulate this data. Management logic 83 in the management server 80 updates the schedules in configuration database 64.

Different management users may implement different schedules within the configuration database 64 via the management server 80 according to individual user privileges. In a simple embodiment, one management user could implement all schedules for all groups of entertainment devices throughout the network. So, for example, the management user establishes a plurality of schedules, each schedule corresponding to a particular domain of operation of entertainment devices as discussed earlier. There may be hundreds of available schedules, each corresponding to a different type of entertainment venue legislative environments business environment etc. In a general sense, each schedule defines a set of attributes for operation of an entertainment device.

In use, an entertainment device 10 is installed in a domain of operation and is given a particular unique identification tag. The management user establishes which schedules are applicable to this device according to its domain of operation and, using the management interface 70, associates that entertainment device with appropriate ones of the available schedules. In practice, each schedule is associated with a group of devices having at least one set of common required or preferred attributes.

Using the data transfer client 28, the installed device 10 establishes communication with the data transfer server 61. Using configuration builder 62, server 61 queries the configuration database 64 and acquires the relevant schedules associated with the installed device 10. The schedules may then be transferred to the entertainment device for use by the installed device 10 to establish its local configuration. Alternatively, and more preferably, the schedules are used to generate required configuration data for the installed device 10 and deliver that configuration data to the device for updating configuration files 27. All the schedules that apply to the installed device are used to determine a subset of attributes that shall prevail in that device. It will be understood that those attributes may include menu items for display to users, content items or ‘payload’ available on the device, and the mode of operation of those content items, as previously discussed.

The kernel process 21 uses the configuration data to retrieve content items 22 either from its open local storage, from remote storage such as content repository 60, or from an), other location determined according to the configuration data. The kernel process then displays or otherwise implements a menu selection according to the prevailing attributes as determined by the schedules.

It still be understood that different schedules may be imposed by different management users, as illustrated in the examples above. The owner of a venue in which entertainment devices are installed may define his or her own schedules to determine the games and other content that are generally available. These may be supplemented by schedules provided bit the supplier of entertainment devices to ensure compliance with local and national regulations. An advertiser may be permitted access to implement schedules that affect certain devices. The local management of the venue may also be permitted to implement schedules to locally vary content according to local tastes or special promotions.

By controlling the range of possible importance weightings, or limits on the magnitude of importance weightings in modifying schedules, it is possible to ensure that each management entity has only the appropriate level of influence over the attributes of a given group of devices.

By carefully controlling access privileges to the schedules for groups of devices, it is possible to ensure that only authorised persons can influence designated attributes of the entertainment devices. For example, schedules that influence legally significant attributes of the devices may be inaccessible to all users except those responsible for legal compliance, and such attributes may be weighted so that they cannot be overruled or influenced by other schedules.

Changes to the schedules during routine use of the networked devices could be implemented on a periodic routine update basis or be forced through in an immediate update process. For example, devices 10 may be configured to periodically check their configuration schedules by connecting with control server 11 on a daily or hourly basis. Non-critical updates requiring significant downloads of new content could be implemented in off-peak hours. Critical updates could be forced by communication with the device 10 being initiated by control server 11. This strategy allows for better use of restricted bandwidth network communications.

The entertainment devices are able to run semi-autonomously in the event of periods of non-availability of the network 14 or some services 40 on the device itself. The importance weighting of menu items in schedules allows the device to adapt to implement content only as and when it and the supporting services are available. Thus, the kernel process 21 is preferably adapted to offer only content items that meet three criteria: a) it is content that is scheduled for that device, b) it is content which is currently available on/downloaded to that device, and c) it is content which is currently fall), supported by peripherals and services on that device.

It will be recognised from the above description that the invention offers a powerful and effective tool for remotely controlling the content offered, mode of operation of, and other attributes of, a large number of entertainment devices in a network, according to a complex set of fixed and variable requirements, by a large number of management users.

Another important aspect of maintaining a network of entertainment devices 10 is the function of event reporting and, more generally, event handling. During operation of an entertainment device 10, numerous different events occur which it may be desirable, essential or legally mandatory to record and/or notify to an appropriate entity. The appropriate entity to which an event should be notified may vary, for example according to: (i) the type of event; (ii) the owner, operator or administrator of the machine or of certain functions of the machine (e.g. cash handling, maintenance, etc), (iii) the physical or geographical location of the device, etc. More generally, the domain of operation may also determine the manner in which event messages should be handled.

Events that should be recorded may include any significant interaction with a user. The user in this context may be a customer, manager, installation engineer, service engineer, cash collection agent etc. The events to be recorded may include identity of games played, payloads executed, the times and amounts of payout events and payin events, cash floats maintained, errors reported by software and/or hardware relating to peripherals and/or content, changes in menus, payloads etc, and completed status of downloads. Events that generate messages generally include changes in the virtual or physical condition of the entertainment device.

More generally, the event recordal process ideally should enable the precise current and/or historic configuration of a device to be confirmed at any given time.

For entertainment devices handling cash, it is desirable that the state of the bank within the machine is known at any given time. For credit-based machines, it is desirable that credit transactions are passed to the relevant credit handling entity at reasonable intervals, and that credit authorisation requests are handled immediately. For juke box type machines, it is desirable that the number of times an audio or video content item is played is accurately and verifiably recorded for the purposes of copyright royalty payments and the like. For routine and critical error events, it is desirable that service personnel are notified in a timely manner according to the criticality of the error.

With further reference to FIGS. 1 and 2, various elements in the entertainment device are capable of initiating event messages that indicate an activity, status or outcome in the entertainment device. For example, the kernel process 21 may initiate, event messages relating to the running of certain payloads or content executables 22, or to the updating of configuration files 51, 52, 53 in the configuration database 27. The peripherals 30 or peripheral handler 35 may initiate event messages relating to payin and payout events, hardware status, faults etc. The entertainment device 10 may also have hardwired and/or software detection systems (not shown) triggered by physical events such as an attack on a machine, or an authorised opening of a cash box to remove or replenish cash. The data transfer client 28 may also initiate event messages relating to opening and closing of network connections to the control server 11 and messaging server 12, and logging downloads/updates from the control server 11. The kernel process 21 may also initiate event messages relating to different users logging into the entertainment device, e.g. management or service users accessing special menus or service options on the device 10. More generally, the event messages may represent any physical and/or virtual event that occurs in the entertainment device 10.

Each event message initiated is sent to the message hub 25 (FIG. 1). As shown in more detail in FIG. 2, message hub 25 includes a messaging module 55. In one implementation, the messaging module 55 includes a messaging component 56 which simply writes a local log file (e.g. in the entertainment device 10) for subsequent debug. The messaging module 55 is also adapted to prepare and transmit event messages to an external entity, such as a data centre. In this respect, the messaging module 55 includes a transmit module 57 which transmits event messages to the remote messaging server 12 over network connection 15. The transmit module 57 includes a message queue 58 to be described later.

Message preparation may include packaging the messages into a standard format and include such generic functions as attaching a source address field and a destination address field. Each event message includes an event tripe (such as ‘cash transaction’, ‘game play’, ‘bank status’ etc. The event types may be arranged in a hierarchical manner to help organise them. Each event message may include a number of information fields giving one or more event value, e.g. a numeric, text or logical state to the event. If the events are arranged hierarchically, any event may have all the attributes of its parent event. Each message is allocated a priority level, which might be explicitly indicated in a priority field of the message, or might be inferred from the event type and/or event value.

In a simple embodiment, only two priority levels might be used. A first priority level indicates that the event message is time critical and should be sent to the message server 12 at the soonest opportunity, e.g. immediately that a network connection 15 becomes available. If a network connection is not presently available, then a first priority level message would indicate that a connection should be established. A second priority level indicates that the message is not time critical (or is less time critical) and need not be sent immediately. Generally, the first priority level event message is referred to herein as having an ‘immediate-send’ or ‘send now’ status, while the second priority level event message is referred to herein as having a ‘non-immediate-send’ or ‘send later’ status.

At important consideration in maintaining a large number of networked entertainment devices 10 is that of communication bandwidth. To maintain permanently open or available communication channels between devices 10 and messaging server(s) 12 may be prohibitively expensive. The messaging module 55 therefore preferably uses the message queue 58 to store event messages that have ‘non-immediate-send’ status. Various triggers may be used to determine when to send queued messages to the messaging server 12. For example, all queued messages, or as many as will fit into a standard transmission packet or chain of messages, may be transmitted periodically. This periodic transmission may be any suitable type, such as (i) as soon as the queue reaches a predetermined length; (ii) as soon as the oldest message in the queue has reached a predetermined age; (iii) as soon as any message in the queue has reached a critical age; or (ill) fixed time, such as every hour, or any combination thereof. Alternatively, or in addition, queued messages may be transmitted whenever an ‘immediate-send’ message arrives, forcing a transmission to the messaging server.

Such an event message sending strategy optimises use of the communications network while maintaining real time transfer of critical data.

It will be understood that more priority levels may be used in the ‘non-immediate-send’ status category. For example, event messages may be given a maximum delay period for transmission to the messaging server. This feature is useful if it must be guaranteed that certain types of status data on the entertainment devices is never more than a predetermined period out of date. It will be understood that messages of the ‘immediate send’ status are sent as soon as possible, i.e. as soon as a communication channel to the messaging server 12 is available. Preferably, this would be practically immediate, but otherwise is intended to mean as soon as a communication channel becomes available.

The message log 56 may be used in a number of different possible ways. For example, it may maintain a permanent or semi-permanent record of event messages or their headers, or may delete event messages after a predetermined time or in response to a user instruction. The message log may store event messages only until receipt has been confirmed by the message server 12. In another arrangement, the queue 58 may reside in the message log, e.g. by flagging unsent messages.

A feature of one preferred embodiment is that the entertainment devices 10 do not need any substantive message routing intelligence. The messaging module 55 is preferably required only to prepare and transmit messages to a message server 12 without knowledge of the ultimate intended recipient(s) of, or subscriber(s) to, the messages. In a preferred embodiment, the messaging server 12 is a message oriented middleware product, such as the IBM MQ series. Each entertainment device 10 may be regarded as a publisher of event messages. Each event message will have one or more subscribers authorised as recipient of the information in the event message. A function of the messaging server 12 is to distribute information from the event messages to relevant authorised subscribers or ‘subscriber entities’. A subscriber entity is depicted in FIG. 1 as a subscriber server 16, which may be any suitable communication device capable of receiving data from the messaging server 12. It will be understood that a large number of subscriber servers may be connected or connectable to the messaging server 12.

Each operator or owner of entertainment devices 10 may be a subscriber to the data from all event messages originating from its respective entertainment devices. A device servicing organisation may be a subscriber to the data from all event messages relating to operational condition of hardware from entertainment devices for which it is responsible. A cash handling or credit handling organisation may be a subscriber to the data from all event messages relating to cash or credit transactions. A regulatory authority or other control body may be a subscriber to data from event messages which can be used to confirm compliance with rules governing use of the entertainment devices such as gambling regulations, amusements-with-prizes regulations, copyright control and royalty collection etc.

In a general aspect, the messaging server 12 is responsible for forwarding all event messages to the correct subscribers according to a classification of a message and/or according to an attribute of the message. The expression ‘message classification’ is intended to encompass a message source identity (e.g. the identity of the device 10 which originated the event message), a source location or domain of operation, a source group or schedule defining device attributes of such a group as previously defined. The expression ‘message attribute’ is intended to encompass event types and event values as previously discussed and may also include time and/or date of origin of the message as well as other content of the message. Thus, a subscriber may elect to receive only error messages from entertainment devices for which it is responsible, and the error status may be determined by either the event type being an error type, or the event value indicating an error, e.g. out of range. Preferably, the message server 12 maintains a profile in respect of each subscriber, which profile determines the messages forwarded to that subscriber.

Message classifications and attributes may be determined according to a hierarchical or tree structure of event messages in which child nodes inherit properties of a parent node. Subscribers may subscribe to certain branches of the message hierarchy, e.g. a node and all children of that node.

The forwarding of messages may take place in several possible ways. In a first arrangement, the messaging server 12 acts a ‘post office’ forwarding entire messages or selected message contents to intended subscribers. Destinations of the messages are determined by a subscription basis of the individual subscribers, i.e. determining which messages a subscriber is authorized to receive. A subscriber server 16 is then used to receive and store event message data as required. Thus, each subscriber receives a subset of the messages received by the messaging server 12.

In a second arrangement, the messaging server 12 may act as a repository for event messages from many devices 10. Individual subscribers 16 may then access event messages to which they are authorized subscribers (i.e. a subset of the received event messages or data) on demand from the messaging server. In this aspect, the forwarding of event messages is ‘on demand’. The expression ‘event messages’ is intended to cover the messages themselves or just the event information or data contained therein.

It will be recognised that a significant advantage in the arrangements of the messaging server as described above is that changes in subscribers to the messaging server can take place without any change in the software or other functionality of the individual entertainment devices. The expression ‘changes in subscribers’ is intended to encompass changes in the subscription basis of one or more subscriber entities, changes in the subscription profile of one or more subscriber entities and/or changes in the subscriber entities themselves including deletion or addition of subscriber entities.

The forwarding of event messages by the messaging server 12 to a subscriber server may operate on a similar basis to that which applies between the messaging module 55 and the messaging server 12, e.g. according to message priority levels corresponding to ‘immediate send’ status and ‘non-immediate-send’ status. The communication channel 17 between the messaging server 12 and subscriber servers 16 may be continuous or intermittent. The messaging server 12 preferably offers guaranteed delivery of messages, even where there is intermittent connectivity between the messaging server and the subscriber servers 16 and thus behaves as a persistent message server.

Although the principal recipient of event messages is the message server 12, the event messages generated by the messaging module 55 may be received or captured elsewhere. For example, a local network (e.g. within a pub or arcade) may have a local management computer system adapted to also receive some or all event messages from an entertainment device using a wired or wireless LAN. Such a local management computer system could include a venue cash management database for local cash flow control. In this aspect, the messaging module may be configured to multicast messages to two or more separate destination addresses. These messages may be in different formats and using different transport protocols. To implement this, the messaging module 55 may include more than one transmit module 57. Still further, the entertainment device 10 itself may monitor event messages and, if there is a predetermined period of inactivity in respect of certain types of event messages, may use this as a trigger to load a different content executable—e.g. a video sequence or different menu likely to attract more attention.

A significant advantage of the use of a message server is that requirements for use of the event messages may be expected to vary more rapidly than changes in the operation of the entertainment devices themselves. Altering software on the entertainment devices to change the rules governing generation, use and destination of event messages is problematic and high risk owing to the number of software modules that would have to be updated. Changing functionality at the message server is a simpler and more controllable task.

Other embodiments are intentionally within the scope of the accompanying claims.

1. A method for operating a network of entertainment devices each having an attached payment mechanism, comprising the steps of:
(i) in each entertainment device, generating a plurality of event messages of different types based on physical and/or virtual events occurring in the entertainment device;
(ii) sending each event message, over the network to a message server;
(iii) forwarding, by the message server, to a plurality of subscriber entities, respective subsets of the event messages received by the message server according to a classification and/or attribute of the messages and according to a subscription basis of the respective subscriber entities.

2. The method of claim 1 in which step (ii) comprises the steps of:
for each event message, determining a priority level of the message and, if the priority level of the message has a ‘non-immediate-send’ status, placing the message in a queue for later sending to the message server or, if the priority level of the message has an ‘immediate-send’ status, sending the message to the message server substantially immediately.

3. The method of claim 2 in which step (ii) further includes sending all queued messages at the same time as sending an ‘immediate-send’ status message to the message server.

4. The method of claim 2 further including the step of periodically sending all queued messages to the message server regardless of the priority level of the queued messages.

5. The method of claim 1 in which step (iii) comprises the steps of:
for each event message received at the message server, determining a priority level of the message and, if the priority level of the message has a ‘non-immediate-send’ status, placing the message in a queue for later sending to the subscriber entity or, if the priority level of the message has an ‘immediate-send’ status, sending the message to the subscriber entity immediately.

6. The method of claim 5 in which step (iii) further includes sending all queued messages at the same time as sending an ‘immediate-send’ status message to the subscriber entity.

7. The method of claim 5 further including the step of periodically sending all queued messages to the subscriber entity regardless of the priority level of the queued messages.

8. The method of claim 1 in which step (iii) comprises the step of storing all event messages for a subscriber entity in a subscriber database at the message server and allowing access to the subscriber database by a subscriber server for retrieval of event message data therefrom.

9. The method of claim 1 further including the step of storing, at the message server, a profile for each subscriber entity, the profile determining the event messages forwarded to that subscriber entity on the basis of one or more of event type, event message source or a schedule to which a source entertainment device is associated.

10. The method of claim 9 further including the step of effecting changes in subscriber entities to the messaging server without requiring any consequent change in the functionality of an entertainment device.

11. The method of claim 1 in which the message server forwards extent messages according to a position of each message within a hierarchical structure defining the classifications and/or attributes of the messages.

12. An entertainment device comprising:
a payment mechanism;
a processor module for executing entertainment content;
a plurality of modules each adapted to initiate event messages corresponding to virtual or physical changes in the condition of the entertainment device; and
a messaging module for sending said event messages to a remotely located message server for onward distribution to subscriber entities based on a classification or attribute of the message.

13. The entertainment device of claim 12 in which the messaging module further includes an event message queue for storing event messages having a non-immediate-send status, and an event message transmit module for substantially immediately transmitting, to the remote message server, event messages having an immediate-send status.

14. The entertainment device of claim 12 in which the event message transmit module includes means for chairing any stored event messages from the event message queue together with an event message having an immediate-send status and sending the chained messages to the remote message server.

15. The entertainment device of claim 13 in which the event message transmit module further includes means for periodically sending queued event messages to the remote message server.

16. The entertainment device of claim 12 in which the plurality of modules adapted to initiate event messages include a kernel process and one or more peripherals.

17. An entertainment system comprising:
a plurality of entertainment devices each having an attached payment mechanism;
a message server connected to the plurality of entertainment devices over a network;
each entertainment device including a plurality of modules adapted to initiate a plurality of event messages of different types based on physical and/or virtual events occurring in the entertainment device, and a messaging module adapted to send each event message, over the network to the message server;
the message server adapted to forward subsets of the event messages received by the message server, to respective pluralities of subscriber entities, according to a classification and/or attribute of the messages and according to a subscription basis of each of the subscriber entities.

18. The entertainment system of claim 17 in which the message server is adapted to provided guaranteed delivery of event messages even when there is intermittent connectivity between the messaging server and the subscriber entities.
